(19) United States
(12) Patent Application Publication
(10) Pub. No.: US 2023/0234262 A1
(43) Pub. Date: Jul. 27, 2023

(54) WORKING UNIT FOR REALIZING HOLES IN A SLAB MATERIAL AND FOR MACHINING THE INNER SIDE OF THE HOLES AND MACHINE TOOL COMPRISING SUCH WORKING UNIT

(71) Applicant: Dario Toncelli, Bassano del Grappa (VI) (IT)

(72) Inventor: Dario Toncelli, Bassano del Grappa (VI) (IT)

(21) Appl. No.: 18/002,104

(22) PCT Filed: Jun. 29, 2021
(86) PCT No.: PCT/IB2021/055798

§ 371 Date: Dec. 16, 2022

(30) Foreign Application Priority Data
Jul. 6, 2020 (IT) 102020000016294

(51) Int. Cl. B28D 7/04; B28D 1/30; B28D 1/00

(52) U.S. Cl. CPC B28D 7/046; B28D 1/30; B28D 1/003

(57) ABSTRACT

Working unit (1) for realizing holes (H) in a slab material (L) and for machining the inner side of the holes (H) thus formed, comprising a work table (2), at least one tool (4, 6) mounted on a motorized spindle, fixed means (8) for supporting the slab (L) and at least one support device (10) comprising a hollow element (11) intended to engage with a slab portion (P). The support device (10) comprises a top portion (12) movable at least between a raised position in which the slab portion (P) is coplanar with the slab (L) and a lowered position in which the slab portion (P) is lowered with respect to the slab (L) and therefore the hole (H) is free of the slab portion (P). The support device (10) comprises means (14) for locking the movable top portion (12) at least in the lowered position.

The present invention relates to the field of machine tools for cutting and machining a material in the form of a slab, preferably consisting of natural or agglomerated stone material, or ceramic material or glass.

In particular, the present invention relates to a working unit for realizing holes in a slab material and for machining the inner side of the holes, preferably for contouring the inner side of the holes.

The present invention also relates to a numerical-control machine tool comprising such a working unit.

In the description below reference will be made to a numerical-control machine tool for realizing holes in a portion of a slab material and for contouring the inner side of the holes after the slab portion, or cutting waste, has been removed at least temporarily from the hole.

The term “hole” is understood as meaning an opening in the slab which is obtained by removing a slab portion cut by performing a through-cut along a continuous closed line.

The machine tool may be for example of the type produced and marketed under the name “Contourbreton” by Breton S.p.a.

This type of machine tool generally comprises a work table and a machining tool mounted on a spindle with a Cartesian movement, namely displaceable in a controlled manner along a beam designed in turn to be displaced with respect to the work table. Alternatively, the spindle may also be of the type with an anthropomorphic movement, namely mounted on a robotic arm or support.

The machining tool may consists alternatively of a cutting or drilling tool designed to form holes in the slab or a tool for shaping or contouring the inner side of the hole, or other types of machining tools.

Moreover, the machining tool may be mounted on a bi-rotational head so as to obtain a 5-axis machine tool.

The tool is movable along a vertical direction so as to pass from a raised non-operating position into a lowered operating position where it is in contact with the slab material to be machined, and vice versa.

The machine tool may also comprise a tool-holder magazine for automatically changing the tool.

The work table consists of a bench on which the slabs to be machined are temporarily placed and clamped in position by means of suitable locking systems.

The slabs to be machined must be clamped in an operating position at a predefined height from the work table, so as to leave between the bottom surface of the slabs and the top surface of the work table sufficient distance to allow the machining tool to penetrate into the slab.

Locking of the slabs may be performed using two different operating methods, i.e.:
using slab locking elements which are slid along T-shaped grooves formed in the work table;
using suction locking and support devices which are positioned on the work table.

In the present description reference will be made solely to this latter operating method.

The suction locking and support devices of the known type may consist of single sucker or double sucker devices.

The single-sucker devices comprise a top hollow element with suction function for locking the slab in position and a bottom end fixed to the work table by means of pins or stops.

After the single-sucker device has been arranged and fixed in a predefined position on the work table, depending on the shape and dimensions of the slab to be machined, the top hollow sucker element is connected to an air suction circuit, for example by means of flexible pipes.

The vacuum which is created inside the hollow element is such as to retain and lock the slab previously positioned on the suction locking device.

The double-sucker devices comprise, in addition to the top hollow element with suction function, also a bottom hollow element with suction function, connected to a suction circuit by means of respective flexible pipes for creating the vacuum inside the bottom hollow element.

The bottom hollow element with suction function allows the double-sucker device to be fixed in position on the work table without using the pins and stops mentioned above.

One drawback of these suction locking and support devices consists in the fact that the top hollow element and the bottom hollow element must be independently connected to the suction circuit.

This drawback results in an increase in the number of suction circuits and systems in the machine tool and hence in more complex management of the machine.

In order to overcome at least partly said drawback machine tools which comprise double-sucker locking and support devices with alternative air suction systems have been developed.

Examples of this type of machine tool are described in Italian patent application No. 102008901620046 and TV2008A000123.

In particular, the machine tools described in the aforementioned documents comprise:
a work table with a plurality of through-openings, preferably arranged in the manner of a grid, which house single shut-off valves for controlling the fluid communication between the top side of the table and a plurality of channels located underneath the table for forming an air suction circuit;
double-sucker locking devices having at the bottom sucker a shaped central seat; the seat is designed to be arranged in a central position with respect to a respective through-opening in the work table and designed to interact with the top end of the closing member of the respective shut-off valve so as to cause it to assume the open condition.

Moreover, the top sucker of the locking and support devices comprises a passage communicating with a cylindrical cavity and a piston comprising a rod is housed inside the cylindrical chamber.

The cylindrical chamber is in fluid communication with the seat of the bottom hollow element.

The advantage of this type of solution lies in the fact that suckers of these locking devices must not be separately connected to the suction circuit in order to create the vacuum inside the hollow elements.

With reference to contouring machine tools, after the hole has been formed in the slab, it is required to remove, at least temporarily, the waste material or slab portion from the hole before proceeding with contouring of the inner side of the hole.

According to a first operating mode, the waste material is removed manually or by means of a sucker pick-up device which engages with the waste material and moves it into a waste material collection zone.

One drawback of this solution consists in the fact that machining of the slab must be interrupted temporarily in order to remove the waste material.

In particular, the interruption in machining of the slab means that it is required to stop operation of the machine, open the protection devices in order to access the working area, remove the waste material, close the protection devices again and restart the machine.

This drawback therefore results in an increase in the overall slab machining time.

In order to overcome at least partially this drawback methods for machining the slabs involving in sequence the following steps have been developed:
realizing the hole in the slab by means of a cutting or drilling tool;
lowering the waste material with respect to the slab, in order to free the hole;
machining, namely shaping or contouring, the inner side of the hole;
raising of the waste material so as to bring it back into the initial position coplanar with the slab;
simultaneous removal of the slab and the waste material, for example by means of a sucker pick-up device, and discharging thereof from the machine.

The machine tools which perform these machining procedures comprise single-sucker or double-sucker devices, similar to those described above, which support the waste material during cutting and are designed to pass from a raised position into a lowered position, and vice versa, so as to move the waste material with respect to the slab.

This solution allows the waste material to be temporarily removed from the hole without interrupting operation of the machine tool and therefore without interrupting machining of the slabs.

In particular, raising and lowering of the waste material is generally performed by means of a pneumatic cylinder of the suction support device which is connected to a pneumatic plant by means of ducts or pipes, or by means of a different non-pneumatic actuator.

However, this solution is also not without certain drawbacks.

A first drawback consists in the fact that the connection of the suction support devices to the pneumatic plant increases the complexity of the machine tool.

Another drawback consists in the fact that the connection of the suction support devices to the pneumatic plant is performed manually.

This drawback therefore prevents the method for machining the slabs from being completely automated.

The main object of the present invention is to provide a working unit for realizing holes in a slab material and for machining the inner side of the holes and a machine tool comprising this working unit, which are able to overcome the aforementioned drawbacks.

A particular task of the present invention is to provide a working unit of the type described above which allows the process of machining the slabs to be completely automated.

Another task of the present invention is to provide a working unit of the type described above which is able to reduce the complexity of the machine tool in which it is installed.

A further task of the present invention is to provide a working unit of the type described above which is able to reduce the overall time required for machining the slabs.

Another task of the present invention is to provide a machine tool comprising the working unit described above, which avoids the need to use a pneumatic plant connected to the support devices in order to move them from a raised position into a lowered position and vice versa.

The object and the main tasks described above are achieved with a working unit for forming holes in a slab material and for machining the inner side of the holes according to claim 1 and with a machine tool comprising such a working unit according to claim 27.

In order to illustrate more clearly the innovative principles of the present invention and its advantages compared to the prior art, non-limiting examples of embodiment will be described below with the aid of the accompanying drawings. In the drawings:

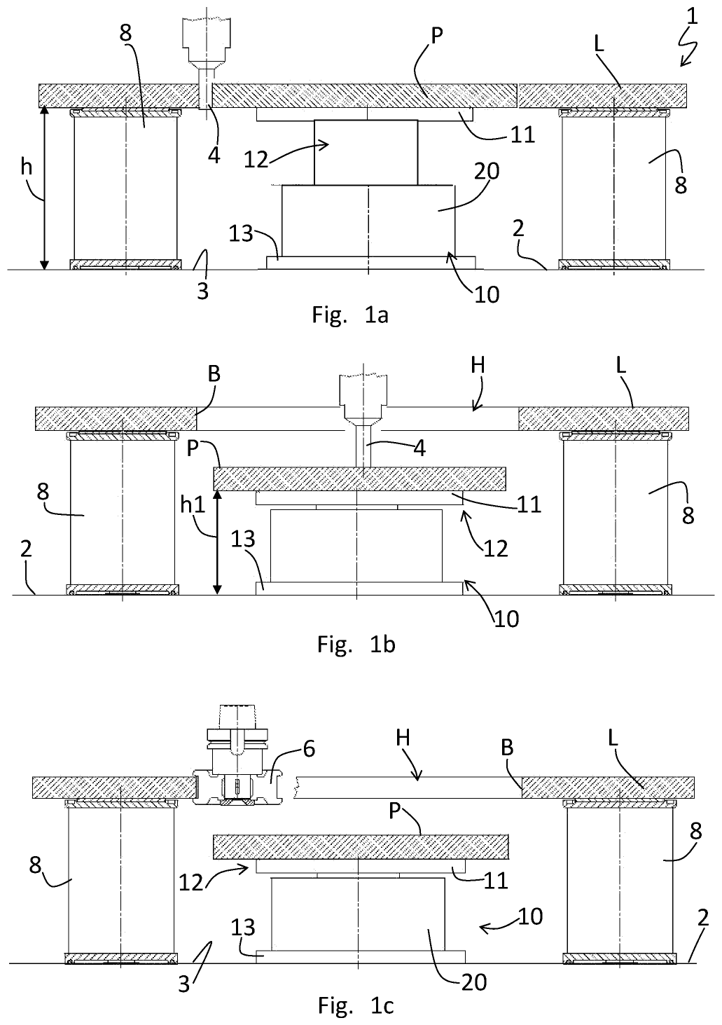

FIGS. 1a-1e show side views of different operating steps during machining of a slab by means of the working unit according to the present invention;

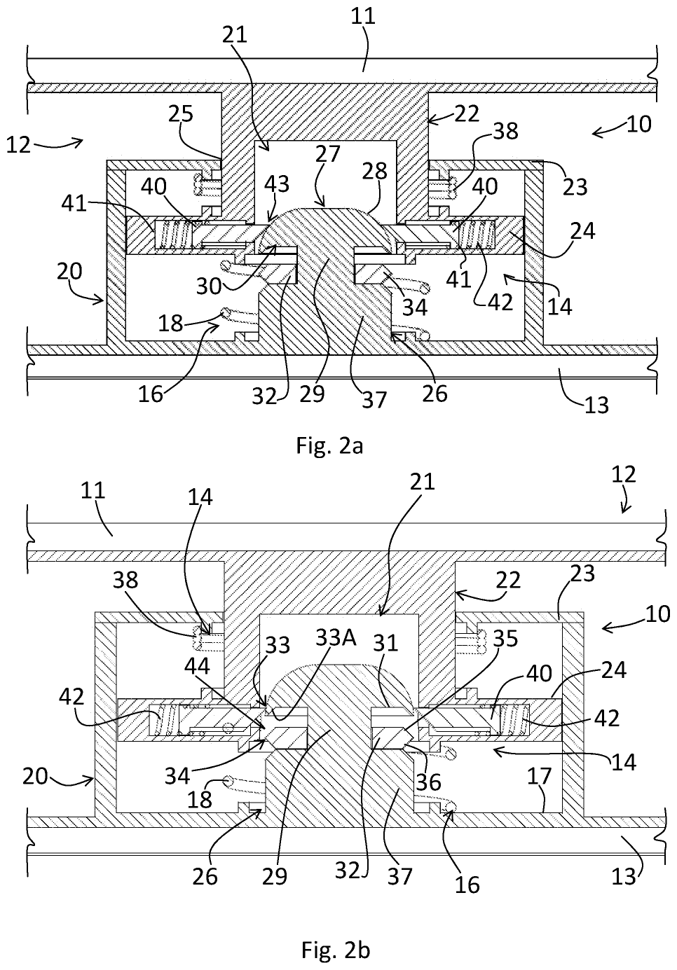

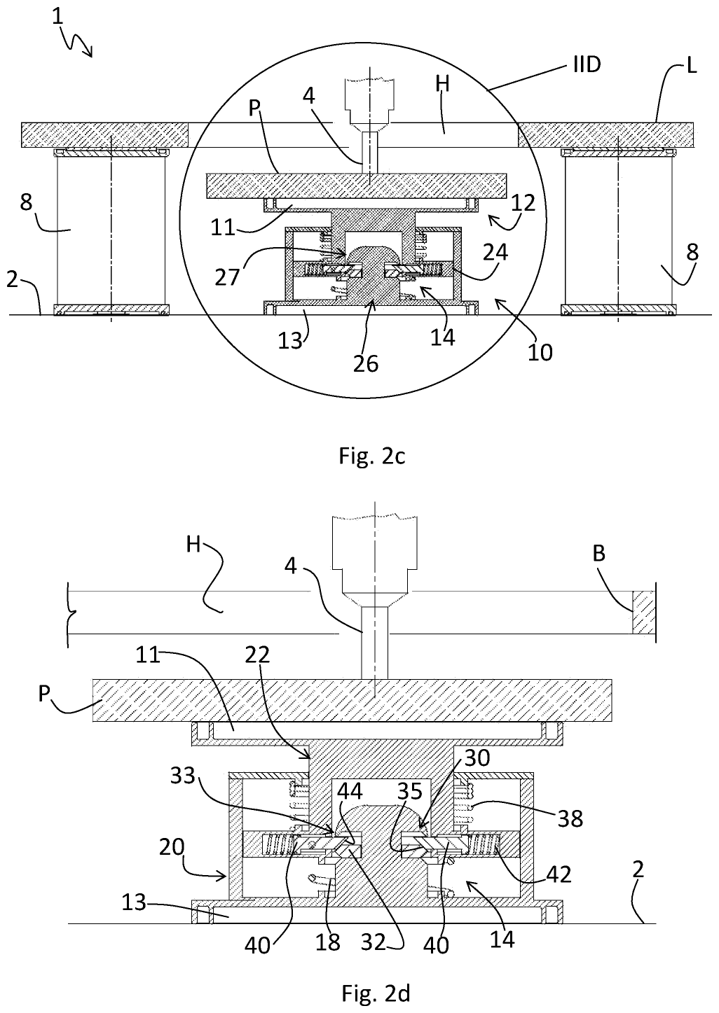

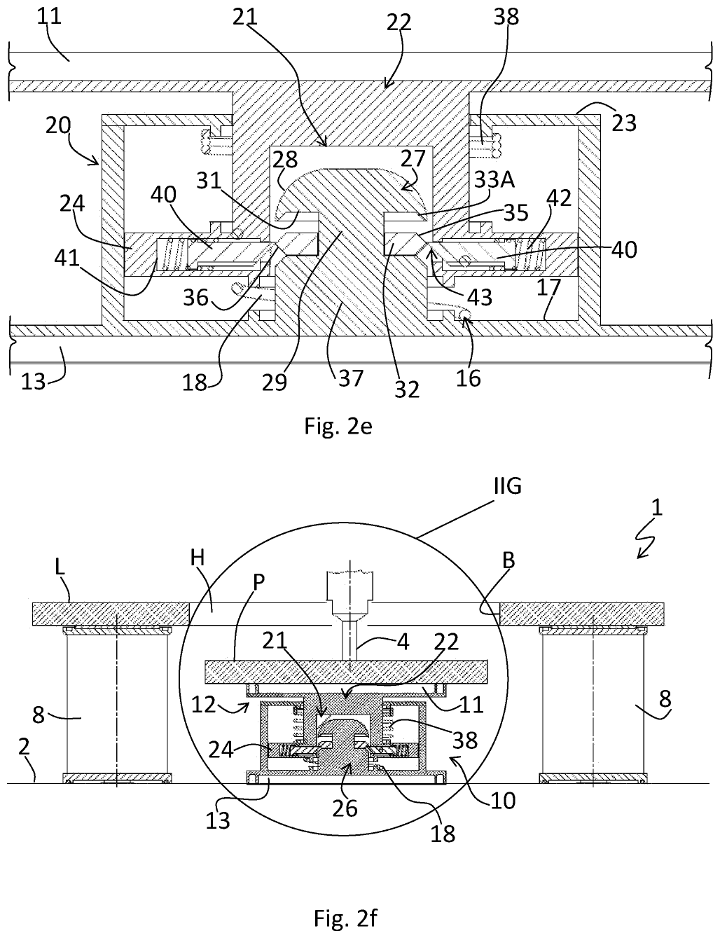

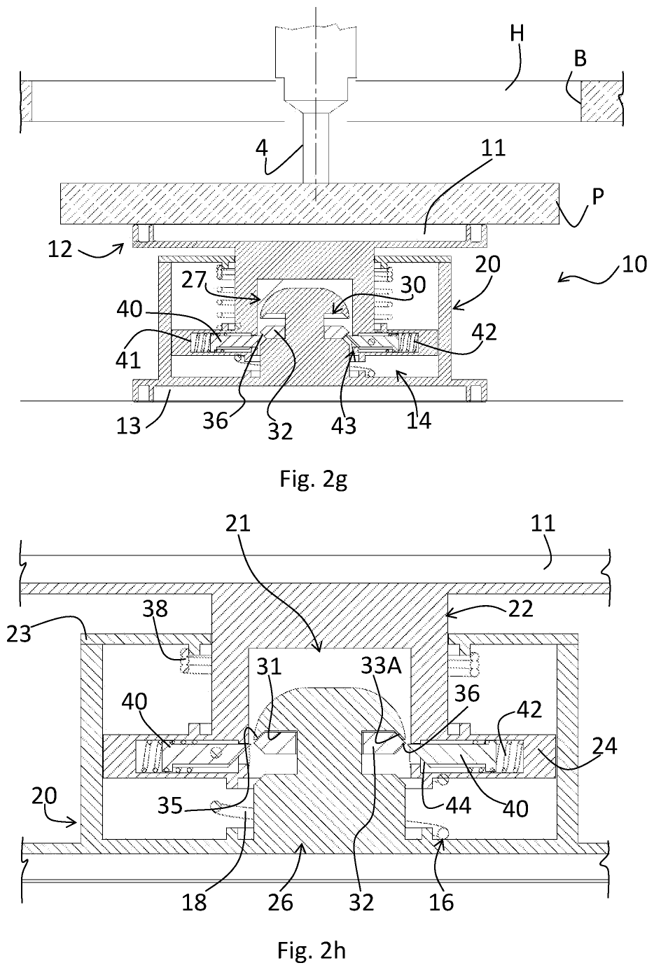

FIGS. 2a-2h show cross-sectioned side view of the working unit according to the present invention or of a detail of the working unit in a first embodiment during different slab machining steps;

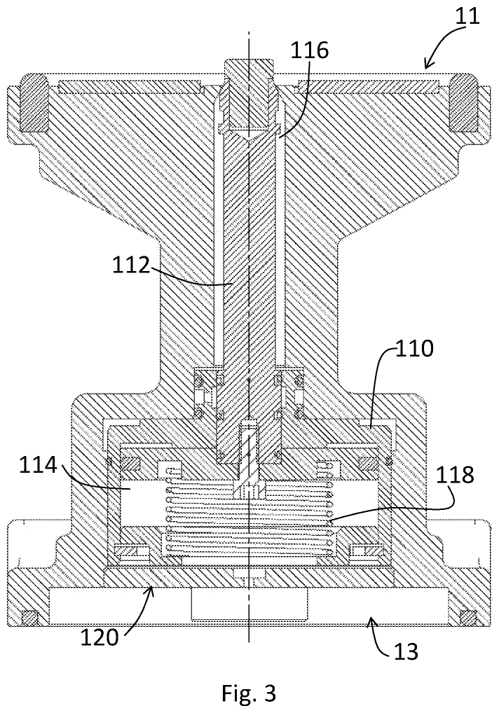

FIG. 3 shows a cross-sectioned side view of a device for supporting the working unit;

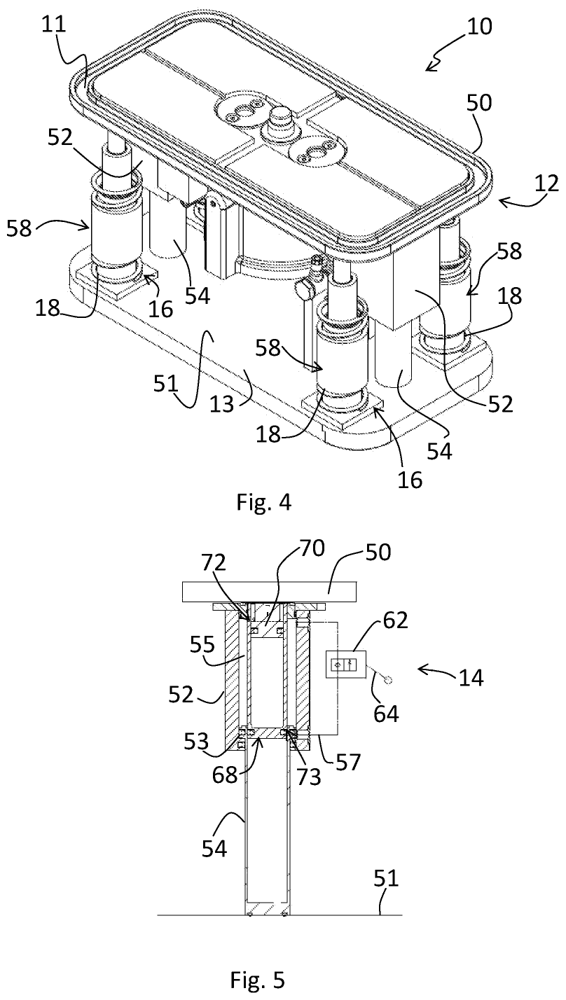

FIG. 4 shows a perspective view of a second embodiment of a device for supporting the working unit according to the present invention;

FIG. 5 shows a cross-sectioned side view of a detail of the support device shown in FIG. 4;

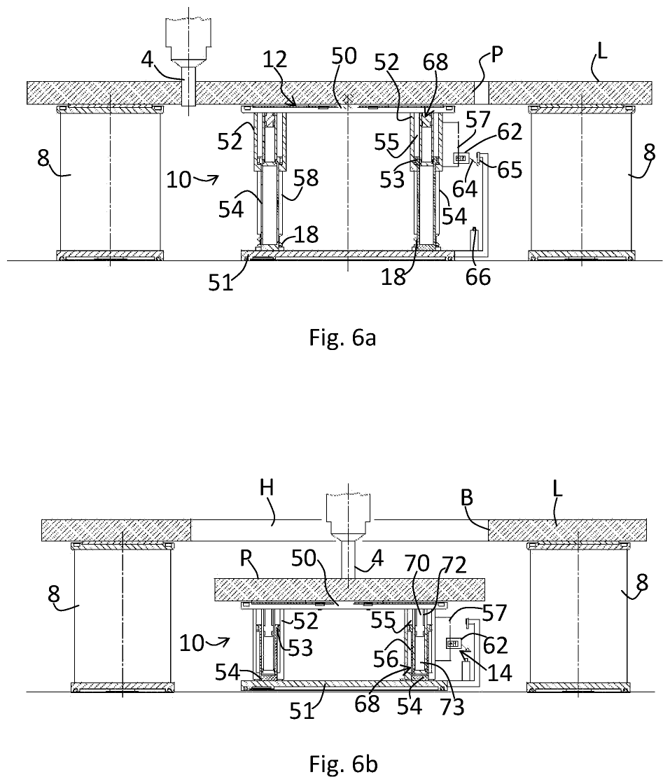

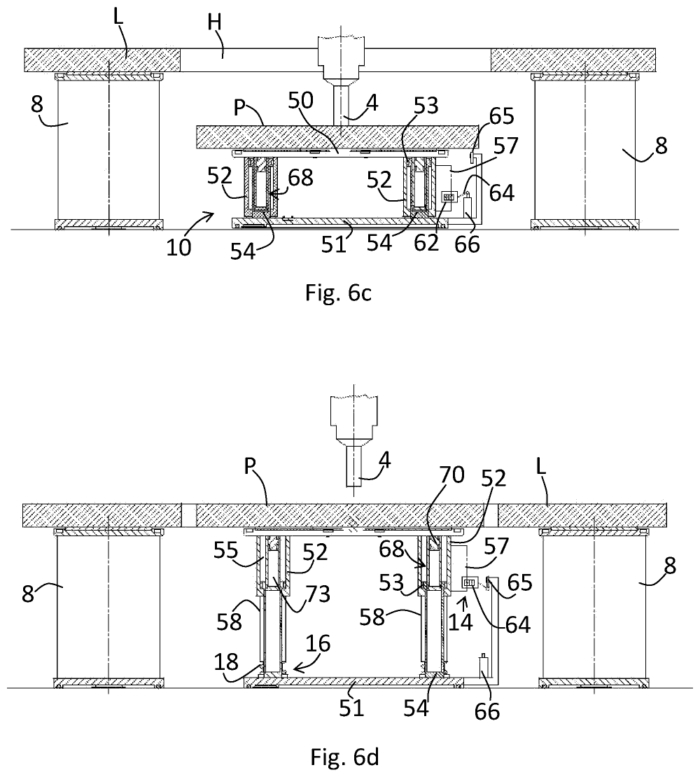

FIGS. 6a-6d show cross-sectioned side views of the second embodiment of the working unit during different slab machining steps;

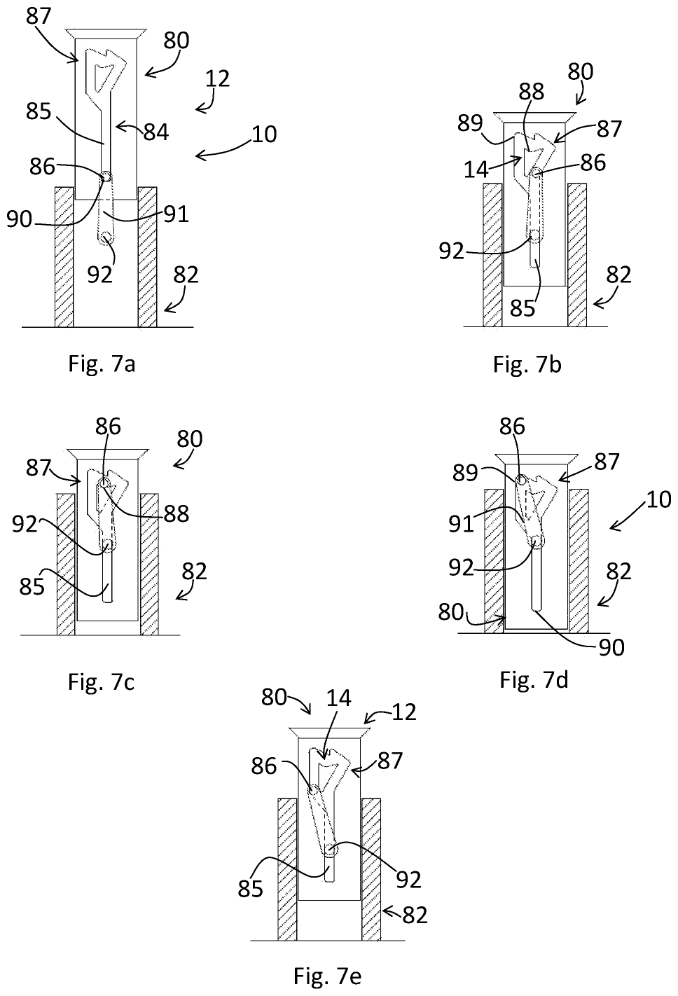

FIGS. 7a-7e show schematic side views of a detail of a third embodiment of the working unit during different operating steps.

With particular reference to the figures, these show a working unit, denoted overall by the reference number 1, for forming holes in a material in the form of a slab and for machining the inner side of the holes thus formed.

In the continuation of the present description “P” will be used to indicate the portion of the slab L which corresponds in terms of dimensions to the hole H formed in the slab L; this slab portion P is also referred to as “machining waste”.

As described more fully below, the working unit 1 comprises a tool consisting alternatively of a cutting or drilling tool for forming holes in the slab or a tool for shaping or contouring the inner side of the holes.

It is also possible to provide other types of machining tools which are known in the sector and different from those indicated above, without thereby departing from the scope of protection of the present invention. For example, the working unit 1 may comprise a flat-head pusher tool, not shown in the figures.

The working unit 1 is designed to machine preferably slabs of stone or stone-like material; however, other types of materials may also be machined, such as ceramic material and glass, without hereby departing from the scope of protection of the present invention.

The working unit 1 is designed to be installed in a machine tool, in particular and preferably of the numerical control type, for machining the slab material.

The machine tool is of the type known per se and not shown in the figures and may be for example a machine tool with an anthropomorphic or Cartesian movement structure.

This latter type of machine tool comprises a work table and a gantry structure with a pair of shoulders designed to slidably support a spindle-carrying beam at the end of the latter.

Moreover, the machine comprises a carriage mounted slidably on the beam; the carriage comprises in turn a sleeve movable vertically with respect to the work table.

At the bottom end of the movable sleeve there is also provided a motorized spindle on which the machining tool of the type described above is mounted; a bi-rotational head which supports the machining tool so as to obtain a 5-axis machining tool may be mounted on the spindle.

The machine tool may also comprise a station for storing the tools to be mounted on the spindle for automatically changing the tool.

The machining tool is movable, by means of the sleeve mounted on the spindle-support carriage and if necessary together with the head where present, along a vertical direction at least between a raised non-operating position and a lowered operating position with respect to the work table.

In accordance with the present invention, the working unit 1 comprises:
a work table 2;
at least one machining tool mounted on a motorized spindle and movable along a vertical direction; the at least one tool consisting alternatively of a cutting or drilling tool 4 for forming a hole H in a slab portion P, a tool 6 for machining, preferably contouring, the inner side B of the hole H, or other types of machining tools;
fixed means 8 for supporting the slab L in an operating position at a predefined height h from the work table 2, said predefined height h being measured on the bottom surface of the slab L;
at least one device 10 for supporting the slab portion P at the hole H and comprising at least one top hollow element 11 with suction function intended to engage with and support the slab portion P.

Advantageously, the fixed means 8 for supporting the slab and the at least one device 10 supporting the slab portion P are fixed to the work table 2 on the upper surface 3 thereof.

In particular, the fixed support means 8 for the slab L are positioned on the work table 2 peripherally with respect to the slab portion P corresponding to the hole H, and their position, such as the position of the at least one support device 10, is chosen depending on the dimensions and the shape of the slab L to be machined.

The working unit 1 may also comprise mechanical stops, not shown in the figures, designed to be fixed to the work table 2 so as to act as lateral contact elements for the edges of the slab L positioned on the work table 2.

Moreover, the working unit 1 may comprise a plurality of support devices 10 depending on the number of holes H to be formed in the slab L and each of the support devices 10 is designed to support a respective slab portion P or the machining waste.

With reference to the suction devices known from the prior art, the support devices 10 may be of the single-sucker type or double-sucker type.

The device with a single sucker has a top end with the hollow element 11 designed to be connected to an air suction system and a bottom end designed to be fixed to the work table 2 by means of pins or stops. This embodiment is not shown in the figures.

The vacuum created inside the top hollow element 11 allows the support device 10 to stably engage with the slab portion P opposite the hole H formed in the slab L.

Preferably, the support devices 10 according to the present invention are of the double-sucker type, as shown more clearly in FIGS. 1a-1c, 2a-2h, 3-4 and 6a-6d.

These support devices comprise, in addition to the top hollow element 11, also a bottom hollow element 13 with suction function intended to engage with the work table 2 in order to fix the support device 10 in position on the work table 2.

In particular, the double-sucker support devices 10 according to the present invention may be of the type shown in FIG. 3 and described in Italian patent application TV2008A000123.

With particular reference to FIG. 3, the support device 10 comprises:
a piston HO with a rod 112 slidably housed inside a cylindrical chamber 114; the top end of the rod 112 projecting inside the top hollow element 11 and the cylindrical chamber 114 being in fluid communication with the bottom hollow element 13;
a passage or duct 116 inside which the rod 112 is slidably housed;
a compression spring 118 positioned inside the cylindrical chamber 114 and having a top end connected to the piston 110 and a bottom end connected to a cover 120 which closes the cylindrical chamber 114 at the bottom.

The support devices 10 of the type described above are designed to be positioned on the work table 2 opposite respective through-openings, not shown in the figures, placed in fluid communication by means of respective shut-off valves with an air suction system, also not shown in the figures.

The air suction system preferably comprises a series of ducts positioned below the work table.

This configuration of the support devices, in combination with the pressure exerted by the slab on the top end of the rod 112, allows suction of the air and the creation of the vacuum inside the hollow elements 11, 13 without the need to connect separately the two hollow elements 11, 13 with the air suction system.

It is to be understood that this configuration of the support device 10, although it is shown only in FIG. 3, may be applied also to all the embodiments shown in the other attached figures.

The at least one support device 10 comprises a top portion 12 movable at least between one raised portion and a lowered portion, and vice versa.

The movable top portion 12 comprises the top hollow element 11 with suction function and supports the slab portion P or machining waste.

The term “top” is understood as meaning that the hollow element 11 and the movable portion 12 are arranged at a greater distance from the work table 2 than the bottom hollow element 13.

When the movable top portion 12 is in the raised position, the slab portion P or machining waste is coplanar with the slab L in the operating position (see FIGS. 1a, 6a and 6d); when the movable top portion 12 is in the lowered position the slab portion P is lowered with respect to the slab L and therefore the hole H is free of the slab portion P (see FIGS. 1b, 1c, 2c, 2f, 6b and 6c).

With the movable top portion 12 of the support device 10 and the slab portion P in the lowered position, the inner side B of the hole H can be accessed by the machining tool, in particular by the contouring tool 6 (see FIG. 1c) so as to perform the contouring of the inner side B of the hole H.

The displacement of the movable top portion 12 between the raised position and the lowered position is made possible by the fact that the slab L in the operating position is positioned at a predetermined height h from the work table 2, as indicated above.

When the movable top portion 12 of the support device 10 is in the lowered position, the slab portion P is located at a height h1 from the work table 2 less than the height h at which the slab L is located in the operating position, as shown in FIG. 1b.

The movement of the movable top portion 12 from the raised position into the lowered position is performed preferably by the drilling or cutting tool 4 which presses against the slab portion P after making the hole H in the slab L, as shown in FIGS. 2c-2d and 6b.

In other words, the drilling or cutting tool 4, after performing its primary function (drilling and cutting) also performs the function of a pushing tool for lowering the slab portion P, disengaging it from the hole H which has just been made.

Moreover, the movable top portion 12 is intended to pass from the lowered position into a bottom position as a result of a vertical downwards pushing force exerted by the machining tool on the slab portion P, as shown in FIGS. 2f, 2g and 6c.

In this case, the tool which causes the movable top portion 12 to pass from the lowered position into the bottom position is preferably the contouring tool 6 which has just performed contouring of the inner side B of the hole H.

For simpler illustration, FIGS. 2f, 2g and 6c show the same drilling tool 4 which allows the movable top portion 12 to pass from the raised position into the lowered position.

In accordance with a particular aspect of the invention, the at least one support device 10 comprises means 14 for locking the movable top portion 12 at least in the lowered portion, these locking means 14 being preferably of the mechanical and/or oil-hydraulic type.

In particular, these locking means 14 do not have to be connected to a dedicated external pneumatic plant, as occurs in the case of the sucker devices known in the sector; therefore this configuration allows the structure of the working unit to be simplified and is such that the slab machining process is completely automated.

Advantageously, the locking means 14 are intended to pass from an operating configuration into a non-operating configuration when the top movable portion 12 passes from the lowered position into the bottom position owing to the downwards pushing force of the tool, in particular the contouring tool 6, exerted on the top surface of the slab portion P.

The transition of the locking means 14 from the operating configuration into the non-operating configuration as a result of the pushing force of the tool on the slab portion P is illustrated more clearly in FIGS. 2e-2g and 6c.

Therefore, when the movable top portion 12 of the support device 10 is in the lowered position the locking means are in the operating configuration; when the movable top portion 12 is in the bottom position the locking means 14 are in the non-operating configuration.

Preferably, the at least one support device 10 also comprises recall means 16, described in detail below, for bringing the movable portion 12 back from the bottom position into the raised position.

Therefore, after contouring of the inner side B of the hole H has been performed, the slab portion P is brought back into the operating position coplanar with the slab L.

At this point, the slab portion P or waste material may be removed from the machine tool together with the slab L, for example by means of sucker pick-up means, not shown in the figures.

The present invention comprises at least three embodiments of the working unit 1 which differ from each other owing to the form of the movable top portion 12 of the at least one support device 10 and the configuration of the locking means 14 and the recall means 16.

The first embodiment of the working unit 1 is shown in FIGS. 2a-2h, the second embodiment is shown in FIGS. 4, 5 and 6a-6d and the third embodiment is shown in FIGS. 7a-7e.

The first and the second embodiment comprise at least one spring 18 with a vertically extending axis having one end fixed to the movable top portion 12 so as to keep it in the raised portion when the spring 18 is in the extended configuration; in the first embodiment the spring 18 is also referred to as “first spring” in the continuation of the present description.

With reference to the first embodiment, the at least one support device 10 comprises a rigid body 20 fixed to the work table 2 by means of the bottom hollow element 13.

The movable top portion 12 comprises a hollow cylinder 22 slidably inserted inside the rigid body 20 so as to pass from the raised position into the lowered position and to the bottom position, and vice versa.

The rigid body 20 has a closed structure comprising at least one horizontal top wall 23 with a central opening 25 for the sliding insertion of the hollow body 22, as shown more clearly in FIG. 2a.

Moreover, the movable top portion 12 comprises a radial flange 24 positioned at the end of the hollow cylinder 22 opposite to the top end of the top hollow element 11, namely at the bottom end of the hollow cylinder 22.

The radial flange 24 is slidably housed inside the rigid body 20 and has a diameter substantially similar to the internal diameter of the rigid body 20.

The rigid body 20 also comprises a base 17 which forms the top wall of the bottom hollow element 13 with suction function, as shown more clearly in FIGS. 2b and 2e.

The locking means 14 comprise a fixed pin 26 housed inside the rigid body 20 and comprising a mushroom-shaped head 27 and a central body 29 integral with the head 27.

The hollow cylinder 22 of the movable portion 12 comprises a cavity 21 designed to house the fixed pin 26 during the movement of the movable portion 12 from the raised position into the lowered position and from the lowered position into the bottom position.

The base 37 of the pin 26 is integral with the base 17 of the rigid body 20 and the shaped head 27 comprises a curved outer surface 28 and a base 30 projecting radially with respect to the central body 29.

The central portion 29 has a narrower cross-section than the shaped head 27 and the base 37 of the pin 26.

Preferably, the base 30 of the shaped head 27 of the pin 26 comprises a flat radial portion 31 and a lowered peripheral projection 33 with an inclined inner surface 33A, as shown more clearly in FIGS. 2b and 2e.

The central body 29 has, mounted thereon, a sliding annular engaging element 32, the function of which will be clarified in detail below; the sliding annular engaging element 32 comprises a central passage for insertion of the central body 29 of the pin 26 and a radial outer edge 34 shaped in the manner of an arrow head.

The arrow-head shaped radial edge 34 therefore comprises a top surface 35 inclined downwards and a bottom surface 36 inclined upwards.

The internal profile of the base 30 of the shaped head 27 formed by the radial portion 31 and by the inclined inner surface 33A is complementary the profile formed by the downwardly inclined top surface 35 of the sliding engaging element 32.

The purpose of this feature will be explained below with reference to the mode of operation of the sliding engaging element 32.

The first spring 18 is arranged vertically and is wound around the fixed pin 26 and comprises a top end fastened to the radial flange 24 of the movable top portion 12 and a bottom end fastened to the base 17 of the rigid body 20.

Moreover, in this first embodiment, a second vertical-axis spring 38 wound partially around the hollow cylinder 22, may be provided.

This second spring 38 has a bottom end fixed to the radial flange 24, on the opposite side to the first spring 18, and the top end fixed to the rigid body 20, in particular to the inner surface of the top wall 23.

When the movable portion 12 is in the raised portion, the first spring 18 is in the extended position and the second spring 38 is compressed, as shown in FIG. 2a; vice versa, when the movable portion 12 is in the lowered position or in the bottom position the first spring 18 is compressed and the second spring 38 is in the extended configuration, as shown in FIGS. 2d-2f respectively.

In the first embodiment the locking means 14 also comprise at least one pair of lateral engaging elements 40 mounted on the movable portion 12; the lateral engaging elements 40 are situated on opposite sides of a centre plane passing through the central body 29 of the pin 26.

In particular, the lateral engaging elements 40 are retractable and housed partially and slidably inside the radial flange 24, preferably inside suitable lateral seats 41 formed in the radial flange 24.

For this purpose the locking means 14 also comprise a pair of springs 42 with a horizontal axis, one for each lateral engaging element 40, housed inside the radial flange 24, in particular inside the seats 41, and having ends fastened on one side to the lateral engaging elements and on the opposite side to the bottom of the seats 41.

The lateral engaging elements 40 comprise respective ends 43 which project from the radial flange 24 towards the cavity 21 of the hollow cylinder 22; these ends have a tooth-shaped profile with an inclined surface 44.

The lateral engaging elements 40 are designed to pass from a non-operating configuration into an operating configuration.

In the non-operating configuration the lateral engaging elements 40, in particular the inclined surfaces 44 of the tooth-shaped ends 43, are in contact with the curved outer surface 28 of the shaped head 27 of the pin 26 when the movable top portion 12 is in the raised position.

This configuration is shown in FIG. 2a.

In the operating configuration with the movable top portion 12 in the lowered position, the tooth-shaped ends 43 of the movable engaging elements 40 are positioned underneath the base 30 of the shaped head 27 of the pin 26 in order to engage with it. This configuration is shown in FIGS. 2c and 2d.

In this configuration, the interaction between the lateral engaging elements 40 and the base 30 of the shaped head 27 of the pin 26 prevents the movable portion 12 from returning into the raised position as a result of the extension of the first spring 18 and the compression of the second spring 38, even after the drilling tool 4 has been raised from the slab L.

In particular, in the operating configuration the top surface of the ends 43 of the lateral engaging elements 40 is in contact with the lowered projection 33 of the head 27 of the pin 26, as shown more clearly in FIG. 2d.

Moreover, in the operating configuration the inclined surface 44 of the ends 43 of the lateral engaging elements 40 abuts against the downwardly inclined top surface 35 of the shaped edge 34 of the sliding annular engaging element 32, as shown more clearly in FIG. 2d.

Therefore, the ends 43 of the lateral engaging elements 40 are locked between the edge 34 of the sliding annular engaging element 32 and the lowered projection 33 of the base 30 of the shaped head 27 of the pin 26. The sliding annular engaging element 32 is in turn locked against the base 37 of the pin 26.

When the movable top portion 12 is in the raised position the horizontal-axis springs 42 are compressed by the pushing force of the curved surface 28 of the shaped head 27 which acts against the tooth-shaped end 43 of the lateral engaging elements 40, as shown in FIGS. 2a and 2b.

In the operating configuration, namely when the movable top portion 12 is in the lowered position, the horizontal-axis springs 42 are extended, since there is no contact with the curved surface 28 of the shaped head 27 of the pin 26, and therefore the portion of the lateral engaging elements 40 which projects from the radial flange 24 towards the cavity 21 of the cylinder 22 of the movable portion 12 has a greater extension so as to engage in the bottom position with the base 30 of the shaped head 27, as shown in FIGS. 2c and 2d.

When the movable top portion 12 passes from the lowered position into the bottom position as a result of the pushing force of the tool 6 against the slab portion P the lateral engaging elements 40 pass again into the non-operating configuration.

In particular, the inclined surfaces 44 of the lateral engaging elements 40 interact with the downwardly inclined top surfaces 35 so as to allow the horizontal sliding of these inclined surfaces 44 when the movable top portion 12 passes from the lowered position into the bottom position, as shown in FIG. 2e.

During the sliding movement, the lateral engaging elements 40 are retracted from the cavity 21 of the hollow cylinder 22 and the springs 42 inside the seats 41 are compressed.

When the movable top portion 12 is in the bottom position, the lateral engaging elements 40, in particular their tooth-shaped ends 43, engage with the inclined bottom surface 36 of the arrow-shaped edge 34 of the sliding annular engaging element 32, as shown in FIGS. 2f and 2g.

In this configuration, the lateral engaging elements 40 are still retracted and the horizontal springs 42 are compressed inside the seats 41.

In this first embodiment, the recall means 16 indicated above comprise the first spring 18 wound around the fixed pin 26 and the second spring 38 partially wound around the hollow cylinder 22.

When the movable portion 12 of the at least one support device 10 is in the bottom position, the first spring 18 and the second spring 38 are no longer locked by the interaction of the lateral engaging elements 40 with the base 30 of the shaped head 27 of the pin 26.

Therefore, the first spring 18 and the second spring 38 are able to raise the movable top portion 12 from the bottom position and consequently also the lateral engaging elements 40 which interact with the movable top portion 12.

During the raising movement, the sliding annular engaging element 32 is displaced by the lateral engaging elements 40 which interact with its inclined bottom surface 36 and therefore slides along the central body 29 of the pin 26 until it abuts against the base 30 of the shaped head 27 of the pin 26, as shown in FIG. 2h.

At this point, by means of the upward pushing force of the first spring 18 and the second spring 38, the inclined surface 44 of the lateral engaging elements 40 slides along the inclined bottom surface 36 of the sliding engaging element 32; in this way the lateral engaging elements 40 are retracted inside the seats 41 and compress the springs 42 inside them.

Conveniently, the lateral engaging elements 40 are disengaged from the inclined bottom surface 36 of the sliding annular engaging element 32 so as to bring the movable top portion 12 into the raised position.

The movable top portion 12 is therefore free to return into the raised position with the lateral engaging elements 40 in contact with the curved surface 28 of the shaped head 27 of the pin 26, as shown in FIG. 2a.

In the second embodiment, shown in FIGS. 4, 5 and 6a-6d, the movable top portion 12 comprises a top plate 50 which defines the top hollow element 11 with suction function for supporting the slab portion P and a bottom plate 51 defining the bottom hollow element 13 with suction function.

Inside the cavity of the bottom plate 51 the vacuum is created for locking the support device 10 on the work table 2.

A series of oil-hydraulic cylinders 52 integral with the top plate 50 and located underneath it and arranged between the top plate 50 and the bottom plate 51 is also provided.

A series of pistons 53 are slidably inserted inside the oil-hydraulic cylinders 52 and are integral with respective hollow rods 54 having a bottom end connected to the base of the support device 10, namely fixed to the bottom plate 51, as shown in detail in FIG. 5 and in FIGS. 6a-6d.

Each piston 53 divides the respective oil-hydraulic cylinder 52 into a top chamber 55 and a bottom chamber 56 connected in fluid communication with each other by means of a duct 57. The duct 57 is shown schematically in FIGS. 5 and 6a-6d.

Each top chamber 55 is filled with an incompressible fluid, preferably oil; the incompressible fluid is designed to pass from the top chamber 55 to the bottom chamber 56 when the top plate 50 passes from the raised portion to the lowered position, with the piston 53 which slides inside the oil-hydraulic cylinder 52.

The at least one support device 10 also comprises a series of telescopic stems 58 having their top ends fixed to the top plate 50 and the bottom ends connected to the work table 2, namely fixed to the bottom plate 51.

Preferably, as shown in FIG. 4, the at least one support device 10 comprises four telescopic stems 58 located at the four corners of the top plate 50 and two oil-hydraulic cylinders 52 with their respective rods 54.

A series of springs 18 is provided, wound around the telescopic stems 58 so as to keep the top plate 50 in the raised position.

In an alternative embodiment, not shown in the figures, the oil-hydraulic cylinders may contain springs inside them; therefore, in this alternative embodiment the telescopic stems are not present

Suitably, the locking means 14 comprise, for each oil-hydraulic cylinder 52, a valve 62 positioned in the duct 57. Even though FIGS. 6a-6d show only one duct 57 with a respective valve 62, it is to be understood that all the oil-hydraulic cylinders 52 comprise a respective duct and a respective valve.

Moreover, each valve 62 is integral with its own oil-hydraulic cylinder 52 and therefore moves together with the top plate 50. This feature is not illustrated in the figures.

The valves 62 are able to switch from an operating configuration into a non-operating configuration, and vice versa. In the operating configuration the valves 62 allow the passage of the incompressible fluid from the top chamber 55 to the bottom chamber 56, but prevent the passage of the incompressible fluid form the bottom chamber 56 to the top chamber 55 of each oil-hydraulic cylinder 52 during the movement of the top plate 50 from the raised position into the lowered position.

Instead, in the non-operating configuration, the valves 62 allow the passage of the incompressible fluid in both directions and in particular from the bottom chamber 56 to the top chamber 55 of each oil-hydraulic cylinder 52.

The valve 62 is in the operating configuration both when the top plate 50 is in the raised position and when the top plate 50 is in the lowered position and in the non-operating configuration when the plate 50 is in the bottom position.

Therefore, in the second embodiment, the locking means 14 act partly also so as to keep the top plate 50 in the raised position.

Advantageously, each valve 62 comprises a control or operating lever 64 for selectively switching the valve 62 from the operating configuration into the non-operating configuration and vice versa.

Furthermore, the at least one support device 10 comprises a top stop 65 and a bottom stop 66 located close to each oil-hydraulic cylinder 52 and designed to interact with the operating lever 64.

In particular, the stops 65, 66 are arranged so that the operating lever 64 is able to interact with them during the movement of the top plate 50 from the raised position into the bottom position and vice versa.

Each valve 62 is designed to pass into the operating configuration when the control lever 64 comes into contact with the top stop 65, namely when the top plate 50 is in the raised position (see FIG. 6a) and into the non-operating configuration when the control lever 64 comes into contact with the bottom stop 66 namely when the top plate 50 is in the bottom position (see FIG. 6c).

The recall means 16 which bring the top plate 50 into the raised position from the bottom position comprise the series of springs 18 described above and wound around the telescopic stems 58.

These springs 18 are designed to bring the top plate 50 into the raised position when the valves 62 are switched into the non-operating configuration, since the incompressible fluid may pass from the bottom chamber 56 to the top chamber 55 and the top plate 50 is free to be raised.

Operationally speaking, according to the second embodiment of the working unit 1, the top plate 50 is kept in the raised position by means of the springs 18 wound around the telescopic stems 58 (see FIG. 6a) and locked by means of the valves 62 in the operating configuration.

Moreover, the top plate 50 is locked in the lowered position again by means of the valves 62 in the operating configuration (see FIG. 6c).

When the movable top portion 12 passes from the raised position into the lowered position, owing to the pushing force exerted by the drilling tool 4, the rods 54 and the pistons 53 slide inside the oil-hydraulic cylinders 52, as shown in FIG. 6b.

During the sliding movement, the incompressible fluid is pushed from the top chamber 55 to the bottom chamber 56; in this configuration the incompressible fluid is unable to pass from the bottom chamber 56 to the top chamber 55 because it is prevented by the valve 62 in the operating configuration.

After performing the contouring operation, the movable top portion 12 which is located in the lowered position is moved downwards by means of the pushing force of the tool 6 until it reaches the bottom position where the valve 62 is switched into the non-operating configuration after interaction of the lever 64 with the bottom stop 66.

In this case also, for simpler illustration the figures show only the drilling tool 4.

Then the tool is raised up again and the springs 18 bring the top plate 50 into the raised position, as shown in FIG. 6d.

In the second embodiment, the at least one support device 10 may comprise, for each hollow rod 54, a tubular element 68 slidably inserted inside each oil-hydraulic cylinder 52, as shown in FIGS. 5 and 6a-6d.

Moreover, each tubular element 68 is fixed to the top plate 50 of the movable top portion 12.

Each hollow rod 54 allows the sliding of the tubular element 68 inside it when the top plate 50 passes from the raised position into the lowered position.

Each tubular element 68 comprises a piston 70 sliding inside the tubular element 68 and designed to define a top chamber 72 and a bottom chamber 73.

The top chamber 72 of each tubular element 68 is in fluid communication with the top chamber 55 of a respective oil-hydraulic cylinder 52, for example via an opening, and is designed to be filled with the incompressible fluid when the top plate 50 passes from the raised position into the lowered position.

The tubular element 68 is able to compensate for the quantity of incompressible fluid pumped from the top chamber 55 to the bottom chamber 56 which is unable to receive the fluid owing to the fact that it has a smaller circular cross-section because of the presence of the rod 54.

In the third embodiment shown in FIGS. 7a-7e, the movable portion 12 comprises a guide profile 80 designed to form a cam, referred to simply as “cam 80”, inserted slidably inside a hollow body 82.

The cam 80 comprises a groove 84 with a closed profile and the locking means 14 comprise a pin 86 slidably inserted inside the groove 84.

In particular, the groove 84 comprises a straight portion 85 connected at the top to a closed-loop portion 87. Furthermore, the closed-loop portion 87 comprises a lower concave section 88 and an upper concave section 89.

The concavity of the lower concave section 88 is directed downwards, namely towards the work table 2, while the concavity of the upper concave section 89 is directed upwards, namely on the opposite direction to the work table 2.

Preferably, the pin 86 slides inside the groove 84 in an anti-clockwise direction during the movements of the movable top portion 12.

Operationally speaking, the pin 86:
is in contact with one end 90 of the straight portion 85 when the movable top portion 12, and therefore the cam 80, is in the raised position (FIG. 7a);
is in contact with the lower concave section 88 when the movable top portion 12, and therefore the cam 80, is in the lowered position (FIG. 7c);
is in contact with the upper concave section 89 when the movable top portion 12, and therefore the cam 80, is in the bottom position (FIG. 7d).

The lower concave section 88 of the groove 84, since it interacts with the pin 86 when the cam 80 is in the lowered position, is also included within the locking means 14 of the present invention as regards the third embodiment.

Advantageously, the pin 86 is formed by one end of an elongated element 91, the other end 92 of which is fastened to the hollow body 82. As shown in FIGS. 7a-7e, the end 92 slides inside the straight section 85 when the cam 80 passes from the raised position to the lowered position, and vice versa.

The downwards movement of the cam 80 as a result of the pushing force of the machining tool 6 allows the displacement of the pin 86 from the lower concave section 88 to the upper concave section 89.

Then the pin 86 is free to come into contact again with the end 90 of the straight portion 85 starting with the upper concave section 89 during the movement of the cam 80 from the bottom position into the raised position owing to the action of the recall means.

From the above it is now clear how the working unit and the numerical-control machine tool are able to achieve the predefined objects.

In particular, the use of at least one device for supporting the slab portion having a movable portion with mechanical and/or oil-hydraulic locking means avoids the use of a dedicated pneumatic plant for connection to the support device.

As a result of this advantageous feature it is possible to reduce the complexity and the overall dimensions of the working unit and reduce the amount of maintenance work required by the working unit. Moreover, this advantageous feature allows the machining of the slabs to be completely automated.

Obviously, the above description of the embodiments applying the innovative principles of the present invention is provided by way of example of these principles and must therefore not be regarded as limiting the scope of the rights claimed herein.

For example, different types of means for locking the movable top portion of the support device may be provided, provided that they are not of the pneumatic type.

1. Working unit (1) for realizing holes (H) in a slab material (L) and for machining the inner side (B) of the holes (H), thus formed, comprising:
a work table (2);
at least one tool (4, 6) designed to be mounted on a motorized spindle of a machine tool and consisting alternatively of a cutting tool (4) for forming the hole (H) in a slab portion (P) or a tool (6) for machining the inner side (B) of the hole (H), or other types of machining tools;
fixed means (8) for supporting the slab (L) in an operating position at a predetermined height (h) with respect to said work table (2), measured on the bottom surface of the slab (L);
at least one device (10) for supporting the slab portion (P), comprising at least one top hollow element (11) with a suction function intended to engage with and support the slab portion (P); said at least one support device (10) comprising a top portion (12) movable between a raised position in which the slab portion (P) is coplanar with the slab (L) placed in said operating position and a lowered position in which the slab portion (P) is lowered with respect to the slab (L) and therefore the hole (H) is free of the slab portion (P), said movable top portion (12) comprising said at least one hollow element (11);
characterized in that said at least one support device (10) comprises means (14) for locking said movable top portion (12) at least in said lowered position.

2. Working unit (1) according to claim 1, characterized in that said locking means (14) are of the mechanical and/or oil-hydraulic type.

3. Working unit (1) according to any one of the preceding claims, characterized in that said movable top portion (12) is intended to pass from said lowered position into a bottom position as a result of a downwards vertical pushing force exerted by said tool (6) on the slab portion (P).

4. Working unit (1) according to claim 3, characterized in that said locking means (14) are designed to pass from an operating configuration into a non-operating configuration when said movable top portion (12) passes from the lowered position into the bottom position.

5. Working unit (1) according to claim 3, characterized in that said at least one support device (10) comprises recall means (16) for the return movement of said movable top portion (12) from said bottom position into said raised position.

6. Working unit (1) according to any one of the preceding claims, characterized in that it comprises at least one vertical-axis spring (18) having one end connected to said movable top portion (12) and designed to keep, in the extended configuration, the movable top portion (12) in the raised position.

7. Working unit (1) according to any one of the preceding claims, characterized in that said locking means (14) comprise a fixed pin (26) with a mushroom-shaped head (27) and at least one pair of lateral engaging elements (40) mounted on said movable top portion (12).

8. Working unit (1) according to claim 7, characterized in that said at least one support device (10) comprises a rigid body (20) fixed to said work table (2), said movable top portion (12) comprising a hollow cylinder (22) slidably inserted inside said rigid body (20) and a radial flange (24) positioned at the bottom end of said hollow cylinder (22) opposite to the top end of said hollow element (11) with suction function.

9. Working unit (1) according to claim 8, characterized in that said at least one spring (18) is wound around said fixed pin (26) and comprises a top end fastened to said radial flange (24), said hollow cylinder (22) comprising a cavity (21) designed to house said fixed pin (26).

10. Working unit (1) according to one or more of claim 7 or 8, characterized in that said mushroom-shaped head (27) of said fixed pin (26) comprises a curved outer surface (28) and a base (30), the lateral engaging elements (40) being designed to pass from a non-operating configuration, where they are in contact with said curved surface (28) when the movable top portion (12) is in the raised position, into an operating configuration, where the lateral engaging elements (40) engage with the base (30) of the shaped head (27) when said movable top portion (12) is in the lowered position.

11. Working unit (1) according to claim 10, characterized in that said lateral engaging elements (40) are retractable and slidably housed inside said radial flange (24), said locking means (14) comprising for each lateral engaging element (40) a horizontal-axis spring (42) housed inside said radial flange (24).

12. Working unit (1) according to claim 8, characterized in that it comprises a second vertical-axis spring (38) wound around said hollow cylinder (22), said second spring (38) having a bottom end fixed to said radial flange (24) and a top end fixed to said rigid body (20).

13. Working unit (1) according to any one of claims 7-12, characterized in that each of said lateral engaging elements (40) has an end (43) with a tooth-shaped profile comprising an inclined surface (44).

14. Working unit (1) according to claim 13, characterized in that said pin (26) comprises a central body (29) integral with the mushroom-shaped head (27) and a sliding annular engaging element (32) mounted on said central body (29), said sliding annular engaging element (32) comprising an outer radial edge shaped in the manner of an arrow head (34) having at least one downwardly inclined top surface (35) which interacts with the inclined surface (44) of the ends (43) of said lateral engaging elements (40) so as to allow horizontal sliding of said inclined surface (44) when the movable top portion (12) passes from said lowered position into said bottom position.

15. Working unit (1) according to claim 14, characterized in that said recall means (16) comprise at least the spring (18) wound around said pin (26) and said second spring (38) and in that the arrow-head shaped edge (34) of the sliding annular engaging element (32) comprises an inclined bottom surface (36), said lateral engaging elements (40) being designed to engage with said inclined bottom surface (36) when the movable top portion (12) is in the bottom position, said spring (18) being designed to raise said lateral engaging elements (40) and said movable top portion (12) from said bottom position, bringing said sliding annular engaging element (32) into contact with the base (30) of the shaped head (27) of said pin (26), and to allow the disengagement of said lateral engaging elements (40) from the inclined bottom surface (36) of said sliding annular engaging element (32) so as to bring said movable top portion (12) into the raised position.

16. Working unit (1) according to any one of claims 1 to 6, characterized in that said movable top portion (12) comprises a top plate (50) defining said top hollow element (11) with sucker function and a series of oil-hydraulic cylinders (52) integral with said top plate (50) and located underneath it, there being provided a series of pistons (53) slidably inserted inside said oil-hydraulic cylinders (52) and a series of hollow rods (54) slidably inserted inside said oil-hydraulic cylinders (52) and a series of hollow rods (54) integral with said pistons (53) and having a bottom end connected to the base of said support device (10).

17. Working unit (1) according to claim 16, characterized in that it comprises a series of telescopic stems (58) having their top ends fixed to said top plate (50), there being provided a series of springs (18) wound around said telescopic stems (58).

18. Working unit (1) according to one or more of claim 16 or 17, characterized in that each of said pistons (53) divides the respective oil-hydraulic cylinder (52) into a top chamber (55) and a bottom chamber (56) which are in fluid communication by means of a duct (57), each top chamber (55) being filled with an incompressible fluid designed to pass from said top chamber (55) to said bottom chamber (56) when the top plate (50) passes from the raised position to the lowered position.

19. Working unit (1) according to the preceding claim, characterized in that said locking means (14) comprise, for each oil-hydraulic cylinder (52), a valve (62) positioned in said duct (57) and designed to switch from an operating configuration, where it prevents the incompressible fluid from passing from said bottom chamber (56) to said top chamber (55) when the top plate (50) is in the raised position or lowered position, into a non-operating configuration, where it allows the incompressible fluid to pass from said bottom chamber (56) to said top chamber (55) when the top plate (50) is in the bottom position.

20. Working unit (1) according to preceding claim, characterized in that each valve (62) comprises a respective control lever (64) for selectively switching said valve (62) from the operating configuration into the non-operating configuration and vice versa.

21. Working unit (1) according to the preceding claim, characterized in that it comprises, for each oil-hydraulic cylinder (52), a top stop (65) and a bottom stop (66) designed to interact with said control lever (64), each valve (62) being designed to pass into the operating configuration when said control lever (64) comes into contact with the top stop (65), namely when said top plate (50) is in the raised position and said valve being designed to pass into the non-operating configuration when said control lever (64) comes into contact with the bottom stop (66), namely when said top plate (50) is in the bottom position.

22. Working unit (1) according to the preceding claim, characterized in that said recall means (16) comprise the springs (18) wound around said telescopic stems (58), said springs (18) being designed to bring the top plate (50) back into the raised position when the valves (62) are in the non-operating configuration.

23. Working unit (1) according to any one of claims 16 to 22, characterized in that it comprises for each hollow rod (54) a tubular element (68) slidably inserted inside each oil-hydraulic cylinder (52), each tubular element (68) comprising a piston (70) sliding inside it and designed to define a top chamber (72) and a bottom chamber (73) inside the tubular element (68), the top chamber (72) of each tubular element (68) being in fluid communication with the top chamber (55) of the respective oil-hydraulic cylinder (52) and being able to be filled with the incompressible fluid when the oil-hydraulic cylinder (52) passes from said raised position to said lowered position.

24. Working unit (1) according to any one of claims 1 to 5, characterized in that said movable top portion (12) comprises a guide profile designed to form a cam (80) slidably inserted a hollow body (82).

25. Working unit (1) according to claim 24, characterized in that said cam (80) comprises a groove (84) with a closed profile, said locking means (14) comprising a pin (86) slidably inserted inside said groove (84).

26. Working unit (1) according to claim 25, characterized in that said groove (84) comprises a straight portion (85) connected at the top to a closed-loop portion (87) with a lower concave section (88) and an upper concave section (89), said pin (86) being in contact with a bottom end (90) of said straight portion (85) when said top portion (12) is in the raised position, in contact with the lower concave section (88) when said top portion (12) is in the lowered position and in contact with the upper concave section (89) when said top portion (12) is in the bottom position.

27. Numerical-control machine tool for machining slabs, characterized in that it comprises at least one working unit (1) according to one or more of claims 1-26.
